(19) United States
(12) Patent Application Publication
(10) Pub. No.: US 2007/0232372 A1
(43) Pub. Date: Oct. 4, 2007

(54) Mobile-phone mounted apparatus and method for carrying personal objects

(76) Inventor: Morgan Plaster, Las Vegas, NV (US)

Correspondence Address: WEISS & MOY PC, 4204 NORTH BROWN AVENUE, SCOTTSDALE, AZ, 85251, US

(21) Appl. No.: 11/398,140

(22) Filed: Apr. 4, 2006

(51) Int. Cl. H04B 1/38; H04M 1/00

(52) U.S. Cl. 455/575.6; 455/90.3

(57) ABSTRACT

A mobile phone mounted apparatus permits a user to carry personal objects, such as keys, cards, and/or paper currency. In one embodiment, the apparatus comprises a money clip that is coupled to a mobile phone, and which permits a user to carry paper currency interposed between the apparatus and a mobile phone. In another embodiment, the apparatus includes one or more card pockets, into which cards may be inserted. The apparatus may further include one or more key pockets, and/or a housing into which personal objects, including for example keys, may be inserted.

### FIELD OF THE INVENTION

The present invention relates generally to mobile telephones and, more particularly, to an apparatus and method for providing an object holder that is attachable to a mobile telephone.

### BACKGROUND OF THE INVENTION

Mobile or “cell” telephones have in recent years achieved extremely wide levels of use in the U.S. and indeed in countries throughout the world. It is typical for persons to carry mobile phones with them throughout their work or school days. Mobile phones may be carried in a pocket, in a purse, or clipped to a belt.

There are other objects that persons typically need to carry when out of the house. These may include keys, credit cards, a driver's license, and folding money. A need exists for an apparatus and method that permits a person to carry, together with a mobile phone, one or more of such personal objects. The present invention satisfies this need, and provides other related advantages.

### SUMMARY OF THE INVENTION

In accordance with an embodiment of the present invention, a phone-mounted carrying apparatus is disclosed. The apparatus comprises, in combination: coupling means adapted to clasp a portion of an exterior of a mobile phone; a tongue brought into proximity with a rear of a mobile phone by the coupling means; and an item of paper currency interposed between the tongue and the rear of a mobile phone.

In accordance with another embodiment of the present invention, a phone-mounted carrying apparatus is disclosed. The apparatus comprises, in combination: a casing, into which may be inserted a mobile phone; and a key pocket on at least one side of the casing.

In accordance with a further embodiment of the present invention, a phone-mounted carrying apparatus is disclosed. The apparatus comprises, in combination: coupling means adapted to clasp a portion of an exterior of a mobile phone; a card carrying assembly comprising at least one card pocket; wherein the coupling means and card carrying assembly are affixed to one another; a tongue brought into proximity with a rear of the card carrying apparatus; and an item of paper currency interposed between the tongue and the rear of the card carrying apparatus.

### BRIEF DESCRIPTION OR THE DRAWINGS

FIG. 1 is a perspective view of a mobile-phone mounted personal object carrying apparatus, consistent with an embodiment of the present invention.

FIG. 2 is a rear view of the apparatus of FIG. 1.

FIG. 3 is a side view of the apparatus of FIG. 1.

FIG. 4 is a top, cross-sectional view of an adjustable mobile-phone mounted personal object carrying apparatus, consistent with an embodiment of the present invention.

FIG. 5 is a side view of the apparatus of FIG. 4.

FIG. 6 is a perspective view of a mobile-phone mounted personal object carrying apparatus, consistent with an embodiment of the present invention.

FIG. 7 is a front view of an upper portion of the mobile-phone mounted personal object carrying apparatus of FIG. 6.

FIG. 8 is an end view of the upper portion of the mobile-phone mounted personal object carrying apparatus of FIG. 6.

FIG. 9 is a side view of the mobile-phone mounted personal object carrying apparatus of FIG. 6.

FIG. 10 is a top view of the upper portion of the mobile-phone mounted personal object carrying apparatus of FIG. 6.

FIG. 11 is a front perspective view of a mobile-phone mounted personal object carrying apparatus, consistent with an embodiment of the present invention.

FIG. 12 is a rear perspective view of a mobile-phone mounted personal object carrying apparatus, consistent with an embodiment of the present invention.

FIG. 13 is a side view of the mobile-phone mounted personal object carrying apparatus of FIG. 11.

FIG. 14 is a perspective view of a mobile-phone mounted personal object carrying apparatus, consistent with an embodiment of the present invention.

FIG. 15 is a side view of the mobile-phone mounted personal object carrying apparatus of FIG. 14.

### DETAILED DESCRIPTION OF THE PREFERRED EMBODIMENTS

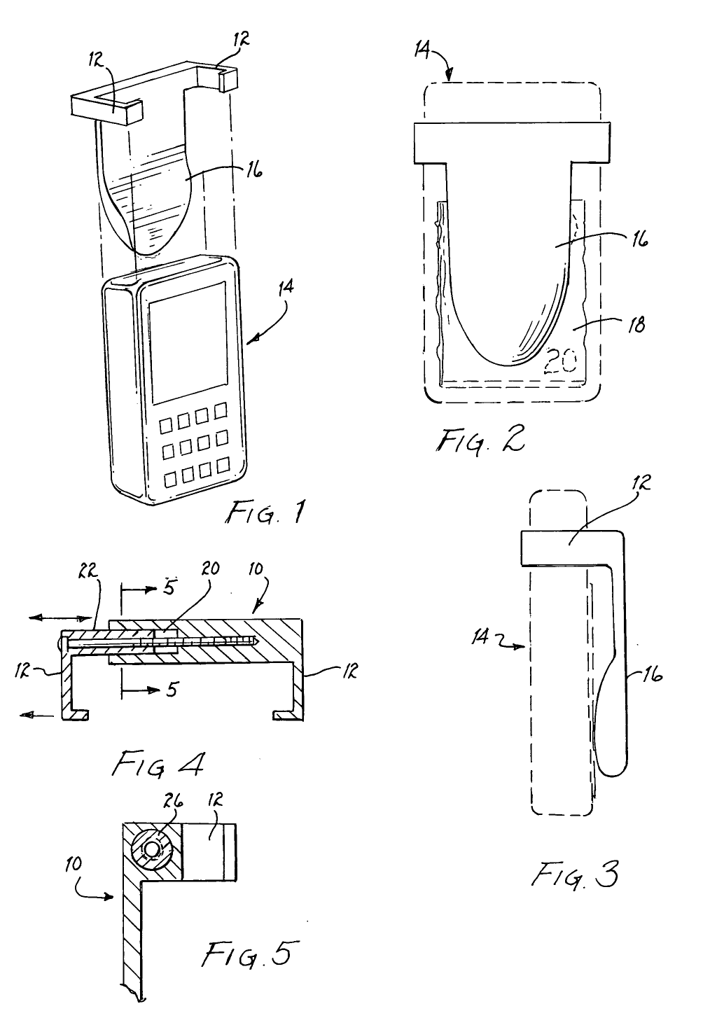

Referring first to FIGS. 1-3, an embodiment of a mobile-phone mounted personal object carrying apparatus 10 (“apparatus 10”) of the present invention is shown. In this embodiment, the apparatus 10 comprises coupling means 12, which may be substantially L-shaped arms as shown herein or which may have a different coupling configuration. The coupling means 12 couple the apparatus 10 to a mobile phone 14. The apparatus 10 further comprises a tongue 16, which extends downward from the coupling means 12.

As best shown in FIG. 4, when the apparatus 10 is in position on a mobile phone 14, the tongue 16 contacts a rear, relatively end portion of the mobile phone 14. As can best be seen by reference to FIG. 2, when coupled to a mobile phone 14, apparatus 10 acts as money clip, with an item of paper currency 18 being held between the tongue 16 and rear portion of the mobile phone 14.

Referring now to FIGS. 4-5, it should be noted that mobile phones 14 do not come in uniform sizes. For examples, some mobile phones 14 are relatively wider than others. In the embodiment of FIGS. 4-5, the space between coupling means 12 is adjustable. The feature of adjustability is achieved, in this embodiment, by providing a female receiving section 20 coupled to (or continuous with) a first coupling means 12, and a male insertion section 22 coupled to (or continuous with) a second coupling means 12. A threaded bolt 24 is inserted through the male insertion section 22, and threadably retained within the female receiving section 20. Rotation of the bolt 24 about knob 26 adjusts the length of penetration of the insertion section 22 into the receiver section 20, and thus the distance between the first and second coupling means 12.

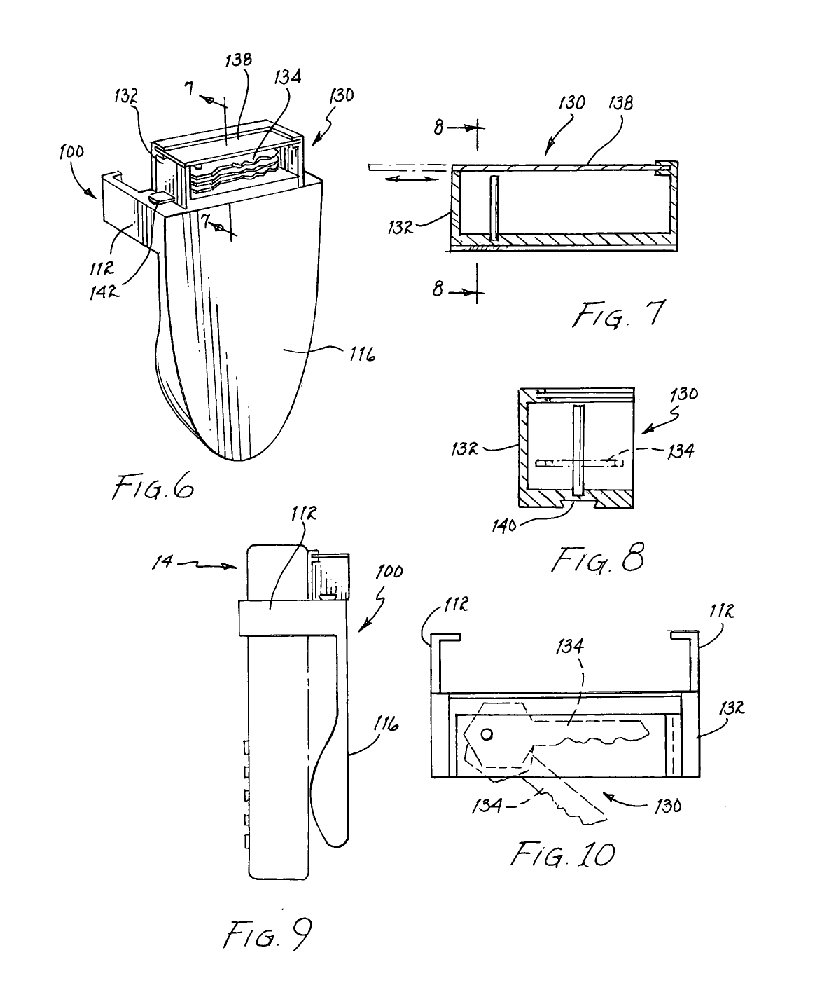

Referring now to FIGS. 6-9, another embodiment of a mobile-phone mounted personal object carrying apparatus, herein referred to as an apparatus 100, is shown. In this embodiment, the apparatus 100 comprises coupling means 112, which may be substantially L-shaped arms as shown herein or which may have a different coupling configuration. As described above with respect to the apparatus 10, the coupling means 112 couple the apparatus 100 to a mobile phone 14. The apparatus 100 may further comprise a tongue 116, which extends downward from the coupling means 112. It may be desired to configure the tongue 116 so that it may act as a money clip, in the manner described above with respect to the apparatus 10.

Attention is now directed to the upper portion of the apparatus 100. In one embodiment, a key case 130 is provided. The key case 130 generally comprises a housing 132, which is sized to accommodate a plurality of keys 134. The key case 130 may further comprise a post 136 located within the housing 132, and onto which keys 134 may be positioned (see especially FIG. 8). In one embodiment, the rearmost side of the housing 132 (as viewed when the apparatus 100 is mounted on a mobile phone 14) is open, so that keys 134 may be rotated about the post 136 for use. See, e.g., FIG. 10.

Referring now to FIGS. 6-7, in one embodiment, the housing 132 further comprises a slidably-mounted cover 138. The cover 138 may be removed from the housing 132, or installed thereon, through a sliding motion, as best seen in FIG. 7.

It may be desired to affix the key case 130 to the apparatus 100 in a more or less permanent fashion. Alternatively, it may be desired to make the key case 130 separable from the remainder of the apparatus 100. Referring specifically to FIGS. 6 and 8, in one embodiment, a groove 140 is provided in the underside of the key case 130, which slidably mates with raised area 142 on an upper portion of the apparatus 100. In this configuration, a user desiring to access on or more keys 134 could first remove the key case 130 by sliding it off of the raised area 142, and thereafter could return the key case 130 to the upper portion of the apparatus 100 by positioning the groove 140 so that it receives the raised area 142 therein as the key case 130 is slid into position along the upper portion of the apparatus 100.

It should be noted that the use of a mating raised area 142 and groove 140 represents only one means for removably coupling the key case 130 to the apparatus 100. Other means, such as hook and loop material, could also be utilized, as desired.

Referring now to FIGS. 11-13, another embodiment of a mobile phone-mounted objecting holding apparatus is shown, hereinafter referred to as “apparatus 200.” The apparatus 200 comprises a casing 202, into which may be inserted a mobile phone 14. Insertion may be through an opening in the bottom portion (not shown) of the casing 202, or otherwise as desired.

On a first side, the casing 202 may have a substantially transparent surface 204, such as one comprised of a clear plastic, to permit a user to see a screen 206 and keyboard 207 of the mobile phone 14. On at least one side of the casing 202, a key pocket 208 may be provided, which is configured to accommodate at least the shaft portion of a key 234. In one embodiment, the head portion of the key 234 protrudes from the key pocket 208, to facilitate removal and reinsertion of the key 234. It may be desired to provide a key pocket 208 on each side of the casing 202.

Referring now to an upper portion of the casing 202, it may be desired to provide a housing 210 thereon. The housing 210 may be desired to carry certain personal objects, including for example one or more keys 234 (not shown), coins, earrings, or other similarly-sized objects. In one embodiment, as for example shown in FIGS. 11-13, the housing 210 has a lid 211 which may be securely closed in position with a snap type closure 212. However, it should be noted that other closing means may be utilized, including for example hook and loop closing means.

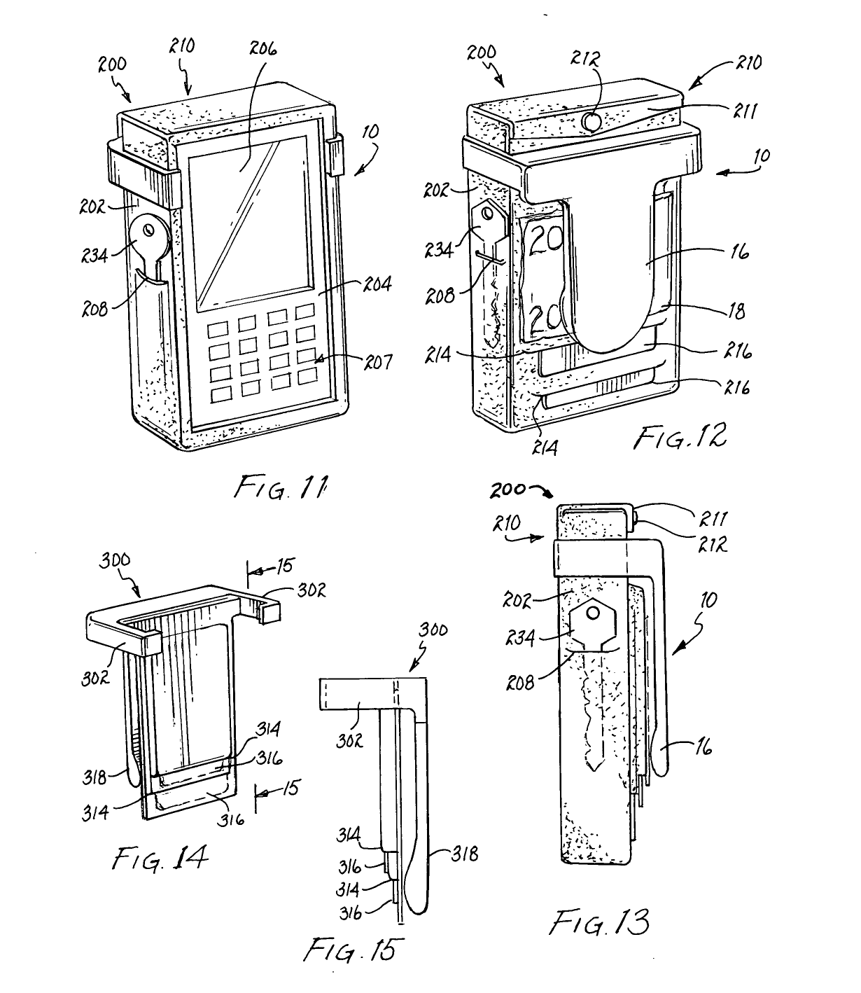

Referring more specifically to FIGS. 12-13, in one embodiment, apparatus 10 may be secured to the casing 202. As shown in FIGS. 12 and 13, when the apparatus 10 is in position on the casing 202, the tongue 16 contacts a rear, relatively end portion of the casing 202. In this configuration, apparatus 10 acts as a money clip, with an item of paper currency 18 being held between the tongue 16 and rear portion of the casing 202.

Still referring to FIGS. 12-13, at least one and preferably a plurality of externally-accessible card pockets 214 may be provided on a rear side of the casing 202. In one embodiment, as shown in these figures, the card pockets 214 are open at an underside thereof, so that a user may withdraw a card 216 located therein without the need to remove the apparatus 10. (The card 216 may be, for example, a driver's license, credit card, business card, etc.) As also shown in these figures, where more than one card pocket 214 is provided, it is preferred that the openings be at different levels, so that a user may conveniently remove a first card 216 located in a first card pocket 214 without disturbing a second card located in a second card 216 pocket 214.

Referring now to FIGS. 14-15, another embodiment of a mobile phone-mounted objecting holding apparatus is shown, hereinafter referred to as “apparatus 300.” The apparatus 300 may utilize first and second coupling means 302 to clasp the exterior of a mobile phone 14. The apparatus 300 may further comprise a one or a plurality of card pockets 314, into each of which one or more cards 316 may be inserted. Still further, the apparatus 300 may include a downward protruding tongue 318, which is positioned so that a portion thereof contacts a rear side of a pocket 314. The tongue 318 is thereby configured to act as a money-clip, and to secure an item of paper money (not shown) between the tongue 318 and the rear side of the card pocket 314.

While the invention has been particularly shown and described with reference to preferred embodiments thereof, it will be understood by those skilled in the art that the foregoing and other changes in form and details may be made therein without departing from the spirit and scope of the invention.

I claim:

1. A phone-mounted carrying apparatus comprising, in combination:
coupling means adapted to clasp a portion of an exterior of a mobile phone;
a tongue brought into proximity with a rear of a mobile phone by the coupling means; and
an item of paper currency interposed between the tongue and the rear of a mobile phone.

2. The apparatus of claim 1 wherein the coupling means comprises two opposing L-shaped members.

3. The apparatus of claim 2 wherein a distance between the two opposing L-shaped members is adjustable.

4. A phone-mounted carrying apparatus comprising, in combination:
a casing, into which may be inserted a mobile phone; and
a key pocket on at least one side of the casing.

5. The apparatus of claim 4 further comprising a personal object housing coupled proximate an upper portion of the casing.

6. The apparatus of claim 5 wherein the personal object housing is sized to accommodate a plurality of keys.

7. The apparatus of claim 6 further comprising a post located within the housing and onto which the plurality of keys may be positioned.

8. The apparatus of claim 7 wherein a side of the housing is open so that at least one of the plurality of keys may be rotated about the post so that a portion of therein extends out of the housing for use.

9. The apparatus of claim 6 wherein the housing is removable.

10. The apparatus of claim 5 wherein a top portion of the housing is slidably retained thereon.

11. The apparatus of claim 5 wherein the housing further comprises a lid which may be secured in a closed position using a snap fastener.

12. The apparatus of claim 1 further comprising a key pocket on each of at least two sides of the casing.

13. The apparatus of claim 4 further comprising at least one card pocket located on a rear side of the casing.

14. The apparatus of claim 4 further comprising at least two card pockets located on a rear side of the casing.

15. The apparatus of claim 4 further comprising:
a tongue positioned in proximity to a rear side of the casing; and
an item of paper currency interposed between the tongue and the rear of the card carrying apparatus.

16. A phone-mounted carrying apparatus comprising, in combination:
coupling means adapted to clasp a portion of an exterior of a mobile phone;
a card carrying assembly comprising at least one card pocket;
wherein the coupling means and card carrying assembly are affixed to one another;
a tongue brought into proximity with a rear of the card carrying apparatus; and
an item of paper currency interposed between the tongue and the rear of the card carrying apparatus.

17. The apparatus of claim 16 wherein the card carrying apparatus comprises at least two card pockets.

18. The apparatus of claim 16 further comprising a personal object housing coupled proximate an upper portion of the apparatus.

19. The apparatus of claim 18 wherein the personal object housing is sized to accommodate a plurality of keys.

20. The apparatus or claim 19 further comprising a post located within the housing and onto which the plurality of keys may be positioned.
